(19) United States
(12) Patent Application Publication
(10) Pub. No.: US 2010/0294900 A1
(43) Pub. Date: Nov. 25, 2010

(54) Adjustable stand

(76) Inventors: Jason I. Maurer, Fredericksburg, TX (US); Charlie Ridley, Fredericksburg, TX (US)

Correspondence Address: LITMAN LAW OFFICES, LTD., PATENT LAW BUILDING, 8955 CENTER STREET, MANASSAS, VA, 20110, US

(21) Appl. No.: 12/453,777

(22) Filed: May 21, 2009

(51) Int. Cl. F16M 11/26; A45F 3/44

(52) U.S. Cl. 248/156; 248/419

(57) ABSTRACT

The adjustable stand is a freestanding, inverted U-shaped structure made from metal tubing that has telescoping vertical members connected to a telescoping crossbar, which adjusts the width of the stand so that the stand is adjustable both in height and width. The upper portion of the structure is also pivotally adjustable, providing the stand with angular adjustment. Hooks may be clamped onto the crossbar or onto the vertical members. The device can provide support for hunting equipment, weapons, clothing, backpacks, and the like. The vertical members have feet that may be staked to the ground for stable support.

### BACKGROUND OF THE INVENTION

1. Field of the Invention

The present invention relates generally to utility stands, and more particularly to an adjustable stand that is portable and can be used to hold hunting equipment, but can also be used as a gun stand for aiming a gun or other hunting weapon.

2. Description of the Related Art

A hunter may wait a very long time for the approach of game. Often, the hunter is situated in a blind and must be absolutely still and quiet while waiting for the game. While the hunter is waiting for the game to approach, it is advantageous to be able to position a weapon, such as a bow or gun, in a location where it is easily reached when the game is sighted by a hunter.

Thus, an adjustable stand solving the aforementioned problems is desired.

### SUMMARY OF THE INVENTION

The adjustable stand is a freestanding, inverted U-shaped structure made from metal tubing that has telescoping vertical members connected to a telescoping crossbar, which adjusts the width of the stand so that the stand is adjustable both in height and width. The upper portion of the structure is also pivotally adjustable, providing the stand with angular adjustment. Hooks may be clamped onto the crossbar or onto the vertical members. The device can provide support for hunting equipment, weapons, clothing, backpacks, and the like. The vertical members have feet that may be staked to the ground for stable support.

These and other features of the present invention will become readily apparent upon further review of the following specification and drawings.

### BRIEF DESCRIPTION OF THE DRAWINGS

FIG. 1 is a perspective view of an adjustable stand according to the present invention.

FIG. 2 is an environmental, perspective view of the adjustable stand according to the present invention.

FIG. 3 is a partial side elevation view of the of the adjustable stand according to the present invention, showing details of a rotating joint connecting the upper and lower portions.

FIG. 4 is a perspective view of a large hook of the adjustable stand according to the present invention.

FIG. 5 is a perspective view of a small hook of the adjustable stand according to the present invention.

Similar reference characters denote corresponding features consistently throughout the attached drawings.

### DETAILED DESCRIPTION OF THE PREFERRED EMBODIMENT

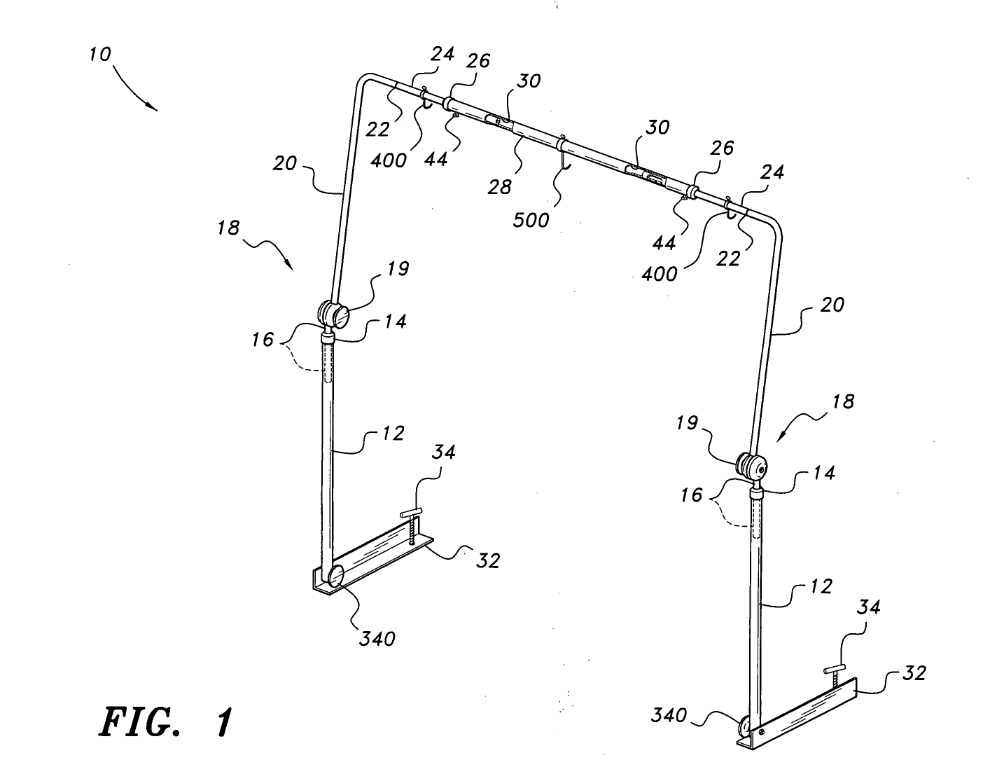

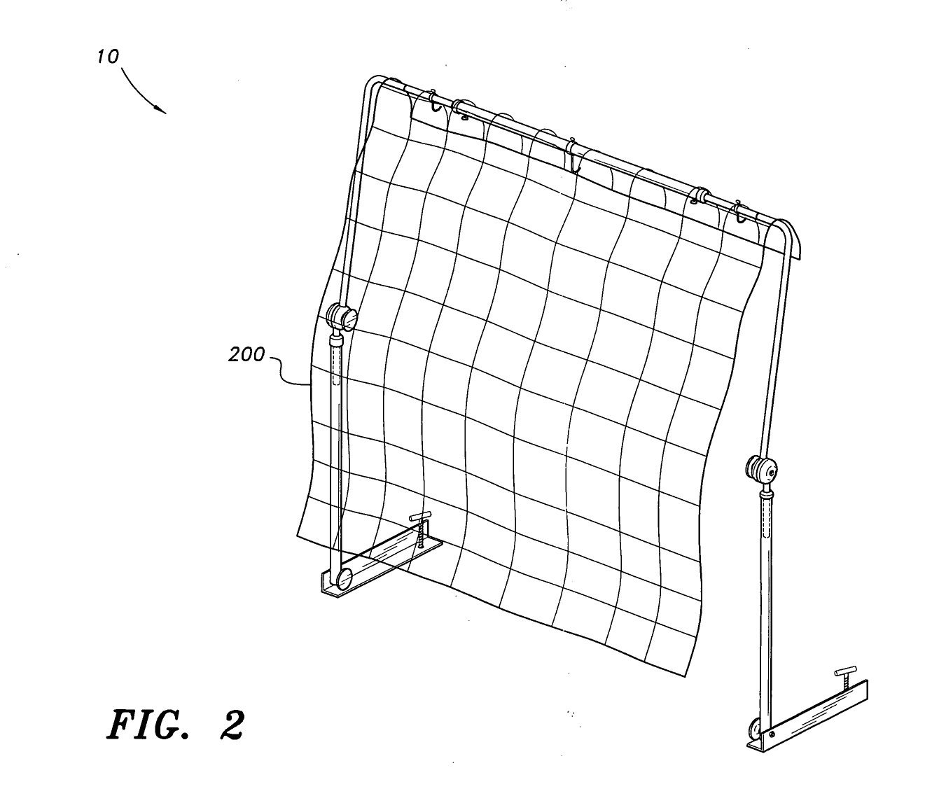

As shown in FIGS. 1-2, the adjustable stand 10 is a freestanding, inverted U-shaped structure, preferably made from metal tubing, that has telescoping vertical members 16 concentrically and slidably disposed in vertical members 12. The height adjustable telescoping vertical members 16 are locked at a desired height by threaded friction rings 14. The support vertical members 12 extend from feet or mounting brackets 32 and are secured in place by knob fasteners 340. The mounting brackets 32 may be secured to the ground by stakes 34 or other anchoring hardware for greater stability, if desired.

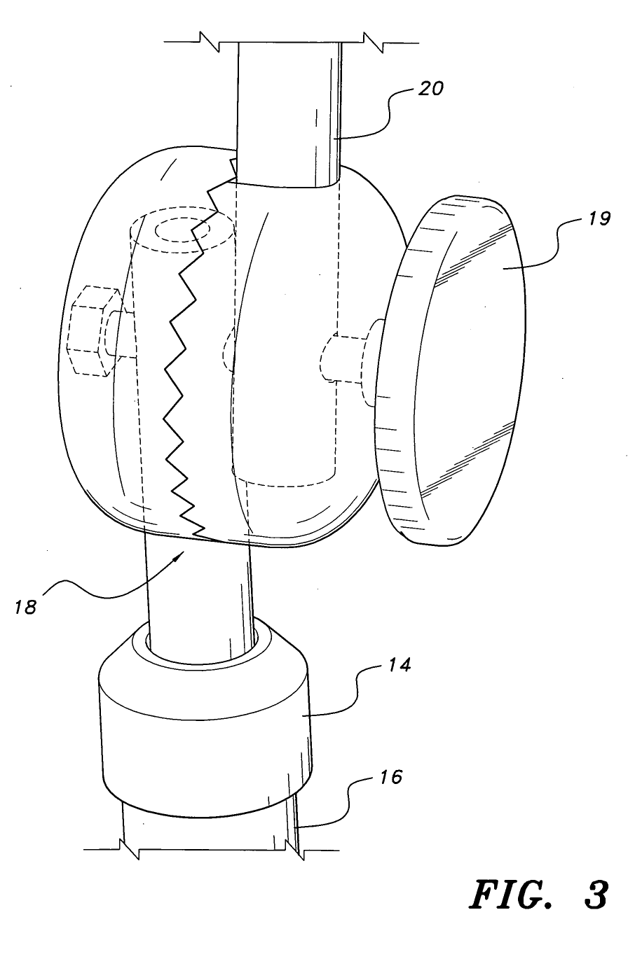

Referring to FIGS. 1 and 3, an upper portion of each telescoping vertical member 16 is connected to a respective stationary member of rotary pivot lock 18. Pipe or tube 20 is connected to a rotating member of rotary pivot lock 18 and extends vertically until its uppermost portion forms an elbow, which extends the member 20 in an inward lateral direction to facilitate connection of lateral crossmembers 24 at joints 22.

Lateral crossmembers 24 telescope inside of lateral support member 30, thereby facilitating width adjustment of the adjustable stand 10. The threaded friction rings 26 are used to lock a desired telescoped configuration, having ends of crossmembers 24 inside of lateral support member 30. Further locking of lateral telescoping members is achieved by contact with a threaded knob 44.

A user of the stand 10 can adjust the vertical height of the crossmembers 24, 30 by adjusting the height of telescoping members 16 in tubes 12, or by loosening pivot lock 18 via pivot lock adjustment knob 19, then swinging the upper assembly to a desired angular displacement with respect to vertical tubes 12. The pivot lock adjustment knob 19 is then tightened to lock teeth of stationary and rotary portions of rotary pivot lock 18 together, thereby locking angular displacement of tubes 20 with respect to tubes 12 while also locking a height of crossmembers 24 and 28. The pivot lock 18 permits the upper portion of the stand 10 to pivot almost 360°. When pivoted and locked 90° from vertical, the crossmembers 24, 30 form a stable gun stand for aiming a rifle or other hunting weapon. The stand 10 has many uses. For example, once the horizontal crossmembers 24 and 28 are height adjusted, a hunter can place a bow, rifle barrel, or other weapon across the lateral members 24 and 28 for support.

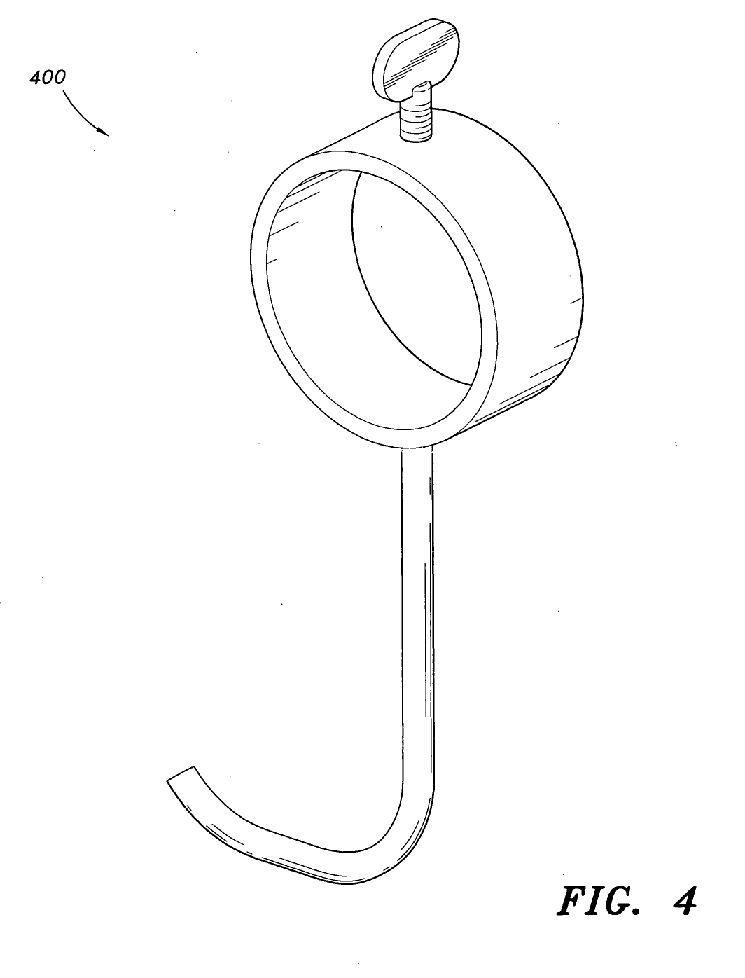

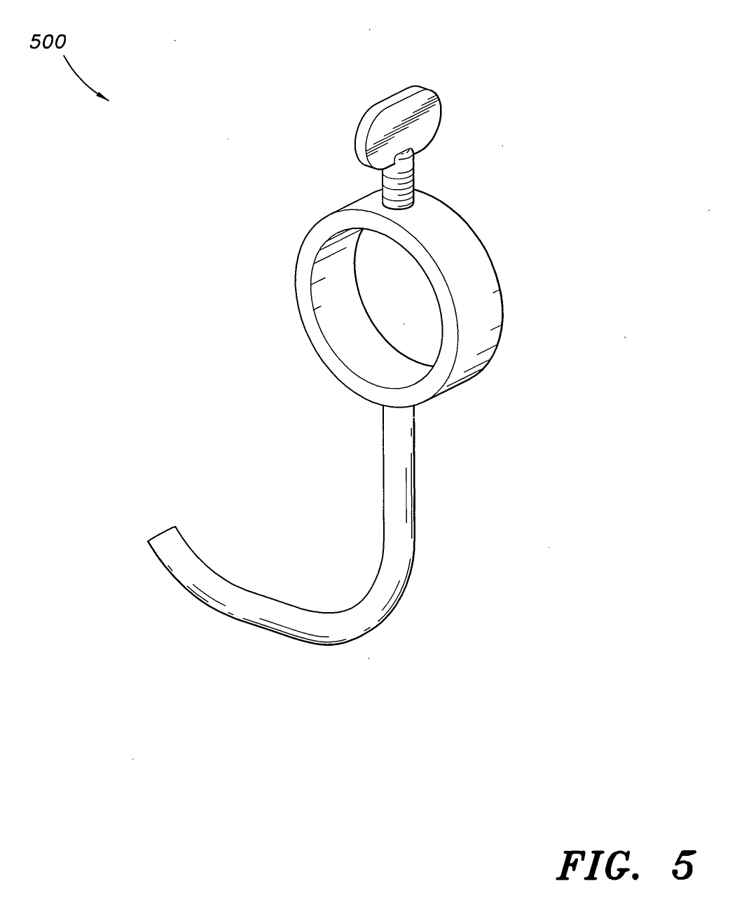

The adjustable stand 10 can also be used to hold a weapon, clothes, backpack, or the like until ready for use. As shown in FIGS. 1, 4, and 5, large hooks 500 or small hooks 400 can be disposed on a portion of the support stand 10. Weapons, clothes, backpacks, and the like may then be hooked onto the stand using the small hooks 400 or the large hooks 500, which may be clamped onto the tubing using the ring and thumbscrew structure at the end of the hook 400 or 500. As shown in FIG. 2, an optional net 200 may be draped over the stand to provide shelter from insects, the elements, or also to provide camouflage. The stand 10 is well adapted for placement inside a duck blind, or the like.

It is to be understood that the present invention is not limited to the embodiment described above, but encompasses any and all embodiments within the scope of the following claims.

We claim:

1. An adjustable stand, comprising:
two support members adapted for placement on the ground;
two telescoping vertical members extending from each of the support members, respectively, the telescoping vertical members adjustably locking at a user-selectable height;
two L-shaped tubes, each of the tubes having an elongate portion and a shorter portion extending at right angles to the elongate portion;
a pair of rotary pivot locks, each of the pivot locks having a locking rotary portion connected to an end of the elongate portion of a respective one of the L-shaped tubes, the L shaped pipe members facing each other in orientation, the pivot locks having a stationary portion connected to a respective end of the telescoping vertical members; and
a telescoping lateral crossmember attached to laterally extending ends of the L-shaped tubes, the telescoping lateral crossmember adjustably locking to a user-selectable width;
whereby the stand is adjustable in width and height, and the L-shaped tubes and the crossmember forming an upper portion of the stand, the upper portion being angularly adjustable with respect to the telescoping vertical members

2. The adjustable stand according to claim 1, further comprising a plurality of hooks attached to the crossmembers.

3. The adjustable stand according to claim 1, further comprising a plurality of stakes securing the support members to the ground.

4. The adjustable stand according to claim 1, further comprising a net hanging from the crossmember.
